(19) United States
(12) Patent Application Publication
(10) Pub. No.: US 2017/0164266 A1
(43) Pub. Date: Jun. 8, 2017

(54) METHOD, DEVICE, AND SYSTEM FOR BACK-END ASSISTED COMMUNICATION ROUTING IN A DISRUPTION TOLERANT NETWORK OF MOBILE STATIONS

(71) Applicant: MOTOROLA SOLUTIONS, INC, CHICAGO, IL (US)

(72) Inventor: YAROSLAV DOMARATSKY, ST. PETERSBURG (RU)

(21) Appl. No.: 15/327,042

(22) PCT Filed: Aug. 8, 2014
(86) PCT No.: PCT/RU2014/000597

§ 371 Date: Jan. 18, 2017

(51) Int. Cl. H04W 40/38; H04W 8/00; H04W 40/18

(52) U.S. Cl. CPC H04W 40/38; H04W 40/18; H04W 8/005; H04W 88/02

(57) ABSTRACT

A first mobile station (MS) in a disruption tolerant network (DTN) reports, to an infrastructure network, contact pattern information comprising identities and indications of times at which the other MSs and infrastructure devices were determined to be within direct communication range of the first MS. The first MS then receives a set of DTN routing rules for routing communications to any target device via the DTN network. The first MS detects a first communication for transmission to a target device via the DTN network and identifies as a function of the set of the DTN routing rules, one or more but less than all intermediary MSs for storing and forwarding the first communication towards the target device. The first MS then transmits the first communication to the identified one or more intermediary MSs when they are determined to be within direct wireless communication range.

### BACKGROUND OF THE INVENTION

Wireless communication systems provide for radio communication links to be arranged within the system between a plurality of user terminals. Such user terminals may be mobile and may be known as ‘mobile stations’ or ‘subscriber units.’ At least one other terminal, e.g. used in conjunction with mobile stations, may be a fixed terminal, e.g. a control terminal, base station, repeater, and/or access point. Such a system typically includes a system infrastructure which generally includes a network of various fixed terminals, which are in direct radio communication with the mobile stations. Each of the base stations operating in the system may have one or more transceivers which may, for example, serve mobile stations in a given local region or area, known as a ‘cell’ or ‘site’, by radio frequency (RF) communication. The mobile stations that are in direct communication with a particular fixed terminal are said to be served by the fixed terminal. In one example, all radio communications to and from each mobile station within the system are made via respective serving fixed terminals. Sites of neighboring fixed terminals in a wireless communication system may be offset from one another or may be non-overlapping or partially or fully overlapping. In another example, mobile stations may operate in a direct mode (e.g., without having to pass through, and without the aid of, other infrastructure devices such as a repeater or base station).

Wireless communication systems may operate according to an industry standard protocol such as, for example, the Project 25 (P25) standard defined by the Association of Public Safety Communications Officials International (APCO), or other radio protocols, such as the TETRA standard defined by the European Telecommunication Standards Institute (ETSI), the Digital Private Mobile Radio (dPMR) standard also defined by the ETSI, the Digital Mobile Radio (DMR) standard also defined by the ETSI, an open media alliance (OMA) push to talk (PTT) over cellular (OMA-PoC) standard, a voice over IP (VoIP) standard, or a PTT over IP (PoIP) standard. Protocols such as PoC, VoIP, and PoIP are implemented over broadband radio access networks (RANs) including third generation and fourth generation networks such as third generation partnership project (3GPP) Long Term Evolution (LTE) networks or IEEE 802.11 standard (e.g., 802.11a, 802.11b, 802.11g, 802.11ac and 802.11p) networks.

Communications in accordance with any one or more of these standards, or other standards, may take place over physical channels in accordance with one or more of a TDMA (time division multiple access), FDMA (frequency divisional multiple access), or CDMA (code division multiple access) protocol. Mobile stations in wireless communication systems such as those set forth above send communications (e.g., including user speech, audio, image data, control signaling, video, etc.), in accordance with the designated protocol. Such communications may be sent directly from one mobile station to one or more other mobile stations directly (e.g., via a direct mode protocol) and/or indirectly via an infrastructure (e.g., via an infrastructure mode protocol).

Many so-called “public safety” wireless communication systems provide for group-based radio communications amongst a plurality of mobile stations such that one member of a designated group can transmit once and have that transmission received by all other members of the group substantially simultaneously. Groups are conventionally assigned based on function. For example, all members of a particular local police force may be assigned to a same group so that all members of the particular local police force can stay in contact with one another, while avoiding the random transmissions of radio users outside of the local police force.

Mobile stations such as push-to-talk (PTT) handsets in particular have been used for some time by emergency personnel but also have recently begun to grow in general popularity. Such mobile stations contain a PTT input that enables the user to communicate with a group of users on the same channel (e.g., a particular physical or logical channel statically or dynamically assigned to a particular talkgroup, or set of otherwise associated mobile stations). The communications between the mobile stations occur at one of a set of isolated frequencies that may be selected, at least in part, by a knob on the mobile stations. To communicate with users on other physical or logical channels, the user may manually switch the channel at the mobile station thereby causing the transmission and reception channel to change (perhaps in conjunction with a frequency assignment by a trunked repeater).

In some situations, mobile stations previously operating within an infrastructure network may temporarily or permanently find themselves outside of infrastructure coverage (e.g., outside of wireless communication range of a fixed terminal). Accordingly, some mobile stations may experience periods lacking end-to-end network connectivity resulting in an inability to reach other mobile stations in situations where a need for aid or a need to provide reconnaissance may, in fact, become more likely to occur. Disruption-tolerant networks (DTNs) are thus characterized by their lack of instantaneous end-to-end paths from a source mobile station to a target device (mobile station or infrastructure device).

Conventional disruption-tolerant networking (DTN) source nodes adapt to the lack of end-to-end paths by widely broadcasting communications or requests therefore to each and every DTN node it encounters in a direct mode in hopes that the communications or request will eventually make it through the ad-hoc network of mobile stations to reach the intended destination mobile station. Such DTN broadcasting, however, results in substantially increased loading on intermediary mobile stations and on DTN network wireless medium resources, and results in inefficient use of such mobile station and wireless medium resources.

Accordingly, an improved device, system, and method is needed for routing communications and requests therefore in a DTN network in a more intelligent and efficient manner, so as to conserve mobile station and wireless medium resources in DTN networks.

### BRIEF DESCRIPTION OF THE SEVERAL VIEWS OF THE DRAWINGS

Embodiments will now be described by way of example with reference to the accompanying drawings, in which:

FIG. 1 is a schematic diagram of a wireless communication system in accordance with an embodiment.

FIGS. 2A-2C are schematic diagrams of movements of mobile stations in a DTN network that are used to illustrate conventional disruption-tolerant networking DTN communications and improved DTN communications in accordance with an embodiment.

FIG. 3 is a block diagram of an illustrative layout of a controller device in accordance with an embodiment.

FIG. 4 is a block diagram of an illustrative layout of a mobile station in accordance with an embodiment.

FIG. 5 is a flow diagram illustrating an example process flow executable at a mobile station in the wireless communication system of FIG. 1 for routing communications or requests therefore across a DTN network, assisted by back-end processing, in accordance with an embodiment.

FIG. 6 is a flow diagram illustrating an example process flow executable at a controller device in the wireless communication system of FIG. 1 for assisting mobile stations in a DTN network with routing communications or requests therefore across the DTN network, in accordance with an embodiment.

### DETAILED DESCRIPTION OF THE INVENTION

In light of the foregoing, it would be advantageous to provide for an improved device, system, and method for routing communications or requests therefore in a disruption tolerant network (DTN) network in a more intelligent and efficient manner, assisted by back-end processing, so as to conserve mobile station and wireless medium resources in the DTN network.

In one embodiment, a method of transmitting communications in a DTN including a plurality of mobile stations, comprises: reporting, by a first mobile station, to an infrastructure network, contact pattern information comprising identities of other mobile stations and infrastructure devices determined to be within direct communication range and indications of times at which the other mobile stations and infrastructure devices were determined to be within direct communication range of the first mobile station; receiving, by the first mobile station, from the infrastructure network a set of DTN routing rules for routing communications to any one of the plurality of mobile stations and infrastructure devices via the DTN network; detecting, by the first mobile station, a first communication for transmission to a target device out of the plurality of mobile stations and infrastructure devices via the DTN network; identifying, by the first mobile station, as a function of the set of the DTN routing rules, one or more but less than all mobile stations (i) currently within wireless communication range of the first mobile station or (ii) not currently within but expected to be within wireless communication range of the first mobile station, to act as intermediary mobile stations for storing and forwarding the first communication towards the target device; and transmitting, by the first mobile station, the first communication to the identified one or more intermediary mobile stations when they are determined to be within direct wireless communication range.

In another embodiment, a mobile station comprises: a direct mode wireless interface for communicating via a DTN; an infrastructure mode wireless interface for communicating with an infrastructure network; a memory; and a processor configured to perform a set of functions, the set of functions comprising: reporting, via one of the infrastructure mode wireless interface and the direct mode wireless interface, to the infrastructure network, contact pattern information comprising identities of other mobile stations and infrastructure devices determined to be within direct communication range and indications of times at which the other mobile stations and infrastructure devices were determined to be within direct communication range of the first mobile station; receiving, via one of the infrastructure mode wireless interface and the direct mode wireless interface, and from the infrastructure network, a set of DTN routing rules for routing communications to any one of the plurality of mobile stations and infrastructure devices via the DTN network; detecting a first communication for transmission to a target device out of the plurality of mobile stations and infrastructure devices via the DTN network; identifying, as a function of the set of the DTN routing rules, one or more but less than all mobile stations (i) currently within wireless communication range of the first mobile station or (ii) not currently within but expected to be within wireless communication range of the first mobile station to act as intermediary mobile stations for storing and forwarding the first communication towards the target device; and transmitting, via the direct mode wireless interface, the first communication to the identified one or more mobile stations when they are determined to be within direct wireless communication range.

In a still further embodiment a method of routing communications in a DTN via infrastructure-network generated DTN routing rules, comprises: receiving, at a radio controller in an infrastructure network, contact pattern information from a plurality of mobile stations, the contact pattern information comprising, for each particular mobile station out of the plurality of mobile stations, identities of other mobile stations and infrastructure devices determined to be within communication range of the particular mobile station and indications of times at which the other mobile stations and infrastructure devices were determined to be within communication range of the particular mobile station; creating, at the radio controller, DTN routing rules as a function of the contact pattern information that, for each of an originating mobile station and target device pair, identifies one or more store, carry, and forward routes but less than all store, carry, and forward routes through the DTN network via one or more identified intermediary mobile stations to reach the target device; and causing, by the radio controller, some or all of the DTN routing rules to be provided, from the infrastructure network, to each of the plurality of mobile stations.

Each of the above-mentioned embodiments will be discussed in more detail below, starting with example infrastructure and DTN network architectures of the systems in which the embodiments may be practiced, followed by a discussion of device architectures of devices operating in the described infrastructure and DTN networks, and ending with a discussion of processes for implementing back-end assisted DTN routing in the infrastructure and in the DTN networks. Further advantages and features consistent with this disclosure will be set forth in the following detailed description, with reference to the figures.

### I. INFRASTRUCTURE AND DTN NETWORK ARCHITECTURES

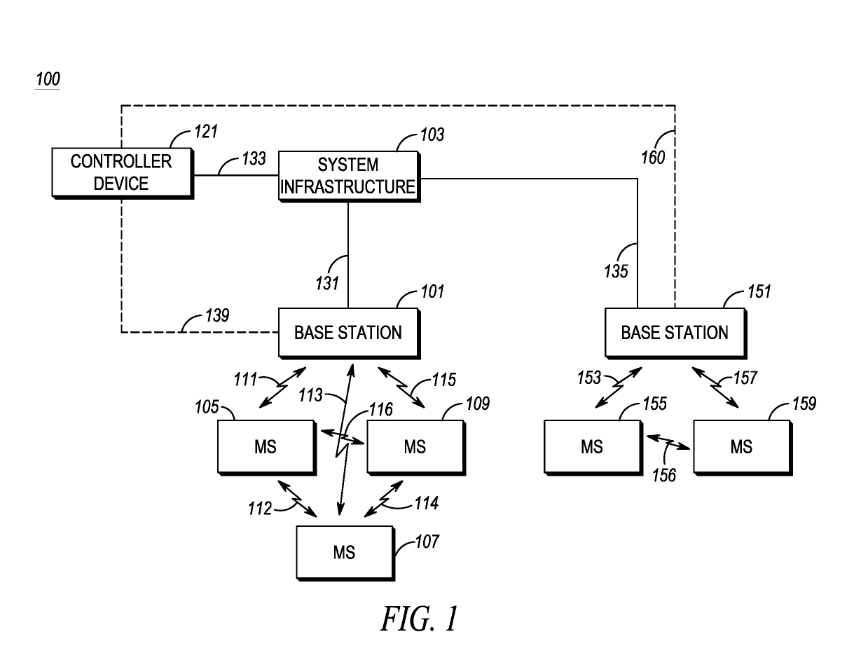

FIG. 1 shows infrastructure and DTN wireless communication system 100, which may be adapted in accordance with an embodiment of this disclosure. In the description below, a DTN network is a network comprised of a plurality of direct-mode mobile stations (MSs) operating without an intervening infrastructure. Any reference to a direct mode network is intended to be equivalent to and/or replaceable with a DTN network, and vice versa. It will be apparent to those skilled in the art that the system 100 and the components which are to be described as operating therein may take a number of forms well known to those skilled in the art. Thus, the layout of the system 100, and of its operational components to be described, should be regarded as illustrative rather than limiting. The system 100 of FIG. 1 will be described as an illustrative wireless communication system capable of operating in accordance with any one or more standard protocols, such as the Association of Public-Safety Communications Officials (APCO) P25 standard, the digital mobile radio (DMR) standard, the Terrestrial Trunked Radio (TETRA) standard, the open media alliance (OMA) push to talk (PTT) over cellular (OMA-PoC) standard, the voice over IP (VoIP) standard, the PTT over IP (PoIP) standard, IEEE 802.11 standard (e.g., 802.11a, 802.11b, 802.11g, 802.11ac and 802.11p) standards, or the 3rd Generation Partnership Project (3GPP) standard, among other possibilities.

The system 100 shown in FIG. 1 includes one or more fixed terminals (e.g., base stations/repeaters/control terminals) (BSs) 101, 151, which may be operably connected to a system infrastructure 103 via respective wired or wireless links 131, 135. While the term BS will be used to refer to the fixed terminal 101, for ease of reference, it should be noted that the fixed terminal 101 may, in some embodiments, be a repeater or some other type of fixed terminal. The BS 101 has radio links with a plurality of MSs, particularly MSs in a service cell or site at least partially defined by a geographic location of the BS 101. In addition to MSs, BS 101 may maintain a direct wireless or wired link 139 (or indirect via system infrastructure 103) with a controller device 121. The controller device 121 may function to receive contact pattern information from MSs in the system 100, and provide corresponding DTN routing rules to MSs in the system 100.

Three MSs 105, 107, 109 are illustrated in FIG. 1 as being within the service area of, and being registered with, BS 101 via respective radio links 111, 113, 115. The MSs may be hand held radios, vehicular radios, laptop or tablet computing devices with integrated radios, or some other device including a processor and a radio consistent with the disclosure set forth herein. In one embodiment, the BS 101 serves MSs including the MSs 105, 107, 109 with radio communications to and from other terminals, including (i) MSs served by the BS 101, (ii) MSs served by other BSs such as BS 151, (iii) other terminals including MSs in other systems (not shown) operably linked to the system 100 via the system infrastructure 103, and (iv) a dispatch console (not shown). In some embodiments, MSs 105, 107, 109 may in addition operate in direct mode communication (DMC) via example radio links 112, 114, 116, in which DMC MSs 105, 107, 109 transmit communications amongst one another without the aid of an infrastructure (e.g., BSs 101, 151, system infrastructure 103, and controller device 121 of FIG. 1).

BS 151 similarly has radio links with a plurality of MSs, particularly MSs in a service cell or site at least partially defined by a geographic location of the BS 151. In addition to MSs, BS 151 may maintain a direct wireless or wired link 160 (or indirect via system infrastructure 103) with the controller device 121 or other operator.

Two MSs 155, 159 are illustrated in FIG. 1 as being within the service area of, and being registered with, BS 151 via respective radio links 153, 157. The BS 151 thereby serves MSs including the MSs 155, 159 with radio communications to and from other terminals, including (i) MSs served by the BS 151, (ii) MSs served by other BSs such as BS 101, (iii) other terminals including MSs in other systems (not shown) operably linked to the system 100 via the system infrastructure 103, and (iv) the dispatch console. In some embodiments, MSs 155, 159 may similarly operate in DMC, via example radio link 156 in which DMC MSs 155, 159 transmit communications amongst one another without the aid of an infrastructure.

The system infrastructure 103 includes known sub-systems (not shown) required for operation of the infrastructure network portion of the system 100. Such sub-systems may include, for example, sub-systems providing authentication, routing, MS device registration and location, system management, and other operational functions within the system 100. The system infrastructure 103 may additionally provide routes to other BSs (not shown) providing cells serving other MSs, and/or may provide access to other types of networks such as a plain old telephone system (POTS) network or a data-switched network such as the Internet. The system infrastructure 103 may also maintain a separate link 133 to the controller 121.

Each of the BSs 101, 151 may operate as a conventional radio site, a trunked radio site, and/or a broadband radio site. In a conventional radio system, a plurality of MSs are formed into groups. Each group uses an associated channel (shared or separate) for communication. Thus, each group is associated with a corresponding channel, and each channel can only be used by one group at any particular moment in time. Channels may be divided by frequency, time, and/or code. In some systems, multiple groups may operate on the same channel, and may use a unique group ID embedded in the group communications to differentiate them. Thus, for example, wireless links 111, 113, and 115 may correspond to a statically assigned single channel (carrying traffic and signaling) made up of a pair of frequencies, including an uplink frequency to handle traffic originating from a MS, and a downlink frequency to handle traffic being repeated to other MSs in the talkgroup (and thus tuned to the downlink frequency of the pair of frequencies).

In a trunked radio system, MSs use a pool of channels for supporting virtually an unlimited number of talkgroups. Thus, all talkgroups are served by all channels. For example, in a trunking system, all MSs operating at a radio site idle on a designated control channel or rest channel and when a new call is requested over the control or rest channel, is assigned a new traffic channel (separated from the control channel by frequency or time slot) for the new group call while remaining MSs not participating in the new group call stay on the designated control channel or rest channel. In other embodiments, when a new call is requested over the control or rest channel, the control or rest channel is converted to a traffic channel for the new call, and a new control or rest channel (separated from the prior control channel by frequency or time slot) is assigned for remaining MSs not participating in the new group call to move to and continue to idle on.

Thus, for example, wireless links 111, 113, and 115 may correspond to a dynamically assigned traffic channel made up of a pair of frequencies, including an uplink frequency to handle traffic originating from a MS, and a downlink frequency to handle traffic being repeated for other MSs in the talkgroup (and thus tuned to the downlink frequency of the pair of frequencies). An additional pair of frequencies may be assigned to BS 101 to act as a control or rest channel, to which MSs 105, 107, 109 would return once a call has ended and traffic has ceased on the assigned traffic channel.

In a broadband radio system, MSs are each assigned their own separate (IP-based) broadband link, and talkgroups and channels are assigned logically and tracked and managed by the system infrastructure 103. Thus, for example, wireless links 111, 113, and 115 may correspond to separate individually assigned traffic channels, each made up of a pair of frequencies, including an uplink frequency to handle traffic originating from a MS, and a downlink frequency to handle traffic being separately repeated for each other MS in the talkgroup. Routing between MSs is handled logically and on an IP-basis by the infrastructure 103, such that communications transmitted by an initiating MS 105 and labeled with the target talkgroup is duplicated within the system infrastructure 103 and separately sent to target MSs 107 and 109 via separate broadband downlinks in wireless links 113 and 115. In the context of the broadband radio system, the frequencies of each separate broadband link 111, 113, 115 are independent of logical channels created over each separate broadband link, and broadband traffic across each link is tagged with a logical identifier that identifies particular broadband traffic as associated with a particular talkgroup. Thus, in this context, a talkgroup identifier and a logical channel identifier may be one in the same and may perform same or similar purposes. In other embodiments, broadband Multicast-Broadcast Single Frequency Network (MBSFN) channels may be used to replace one or both of the downlinks 113, 115. Other possibilities exist as well.

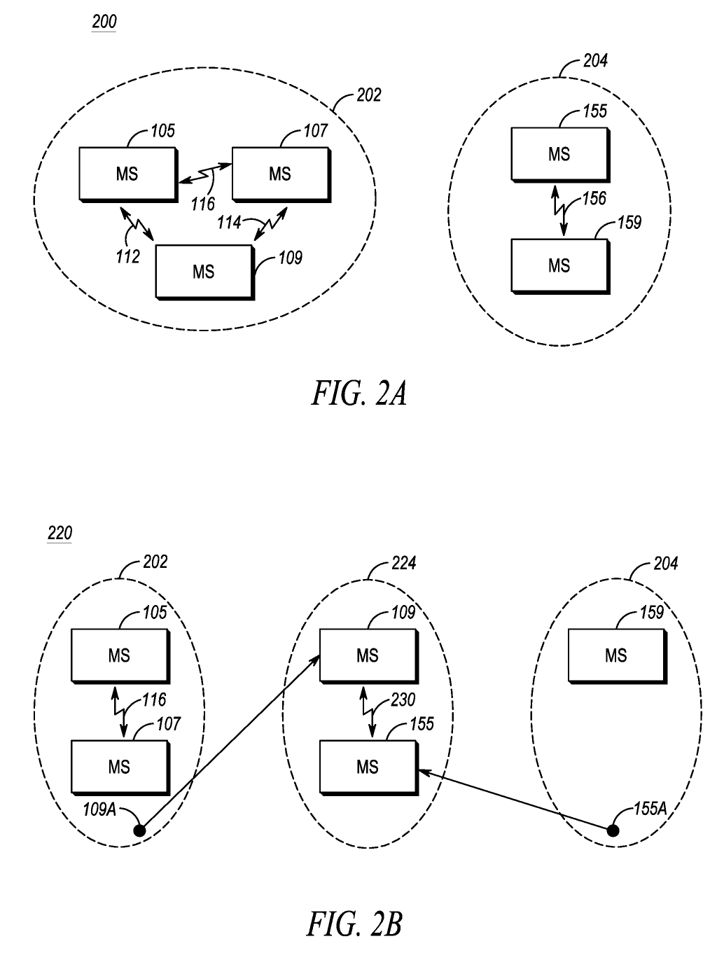

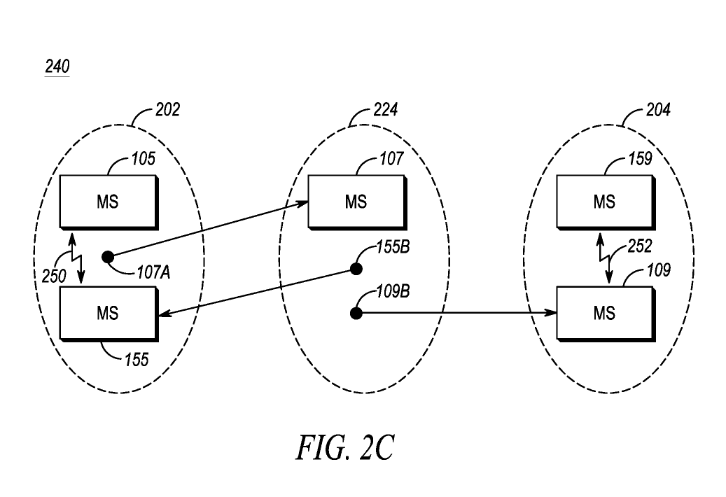

In a DMC radio network, BSs 101, 151, system infrastructure 103, and controller device 121 (and corresponding links) would not exist or may exist but are not used or are not accessible to the MSs. DMC is a communication technique where any MS can communicate with one or more other MSs without the need for any additional infrastructure equipment (including base stations or repeaters). Direct mode operation can therefore provide a more efficient, less costly communication system than repeater mode operation. Thus, for example, a DMC radio network may be comprised solely of DMC MSs 105, 107, 109 and intervening wireless direct links 112, 114, and 116. A separate DMC network of DMC MSs 155, 159 may be created via intervening wireless direct link 156. DMC networks are disclosed in more detail with respect to FIGS. 2A-2C.

FIGS. 2A-2C set forth a further schematic diagram illustrating how DMC networks may change over time as MSs roam out of range of each other and into range of new and/or different MSs. FIG. 2A represents a first DMC network layout 200 having an arrangement of MSs similar to FIG. 1. More specifically, a first DMC network 202 includes MSs 105, 107, and 109 within direct wireless communication range of one another and communicating via DMC links 112, 114, and 116, while a second DMC network 204 includes MSs 155 and 159 within direct wireless communication range of one another and communicating via DMC link 156. While two separate DMC links 112 and 114 are shown between MS 109 and the remaining two MSs 105 and 107, in some embodiments such as when MS 109 is an originating MS transmitting a call to MSs 105 and 107, DMC links 112 and 114 may represent a same DMC broadcast or multicast link. In other embodiments, when MS 109 is an originating MS transmitting an individual and/or unicast call to a single MS such as MS 107, DMC link 114 may be the only active link associated with MS 109 and DMC link 112 may be at least temporarily inactive. Other examples are possible as well, and similar considerations apply when other MSs are the originating MS. As illustrated in FIG. 2A, there is no communication link between the disparate DMC networks 202, 204, such that there is no communication path between MSs 105, 107, 109 in DMC network 202 and MSs 155, 159 in DMC network 204.

FIG. 2B illustrates a second DMC network layout 220 created by the movement of MS 109 from its prior location 109A in the first DMC network 202 to a new location in a third DMC network 224 created due to the MS's 109 newfound proximity to MS 155, which itself has moved from its prior location 155A in the second DMC network 204 to a new location in the third DMC network 224. MSs 109 and 155 negotiate a new DMC link 230 to thus create the third DMC network 224 when they find themselves within range of one another. MSs 105 and 107 remain in the first DMC network 202 and continue to communicate via DMC link 116. MS 159 remains in the second DMC network 204 and periodically or semi-periodically searches (e.g., scans one or more known channels, perhaps in a list of programmed DMC channels stored in a code plug of the device) for another MS to connect to. As illustrated in FIG. 2B, there are no communication links between the disparate DMC networks 202, 224, 204, such that there is no communication path between MSs 105, 107 in DMC network 202, MSs 109, 155 in DMC network 224, and MS 159 in DMC network 204.

FIG. 2C illustrates a third DMC network layout 240 created by the movement of MS 109 from its prior location 109B in the third DMC network 224 to a new location in the second DMC network 204, the further movement of MS 155 from its prior location 155B to a new location in the first DMC network 202, and the further movement of MS 107 from its prior location 107A to a new location in the third DMC network 224. MS 107 remains in the third DMC network 224 periodically or semi-periodically searching for another MS to connect to. MSs 105 and 155 negotiate a new DMC link 250 in the first DMC network 202 when they find themselves within range of one another, and MSs 159 and 109 negotiate a new DMC link 252 in the second DMC network 204 when they find themselves within range of one another. As illustrated in FIG. 2C, there are no communication links between the disparate DMC networks 202, 224, 204, such that there is no communication path between MSs 105, 155 in DMC network 202, MS 107 in DMC network 224, and MSs 109, 159 in DMC network 204.

As a result of the disconnected state of the DMC networks 202, 204 in FIG. 2A and 202, 224, 204 in FIGS. 2B and 2C, an originating MS in DMC network 202 wishing to transmit a particular communication (e.g., audio, data, control, etc. or a request therefore) to a target device (in this case, a target MS) in DMC network 204 cannot do so directly. In some conventional systems, the originating MS may simply wait until it happens to fall within the same DMC network as the desired target MS to transmit the particular communication directly to the target MS. In other conventional systems, the originating MS may further broadcast the particular communication it desires to send to the target MS to all intermediary MSs in its current DMC network and any future DMC networks it joins (e.g., originating MS 105 could broadcast a communication it desires to send to target MS 155 to all MSs 107, 109 in its current DMC network in FIG. 2A) in hopes that any one of those MSs 107, 109 (or any other MSs that MSs 107, 109 themselves come into contact with in the future that haven't already stored the particular communication) may eventually find their way to within wireless communication range of the target MS and provide the particular communication to the target MS. The latter is an example of a so-called conventional “store-and-forward” DTN communication technique.

Applying the conventional “store-and-forward’ technique to FIGS. 2A-2C, if MS 105 in FIG. 2A determines that it needs to transmit an image it captured to MS 159, the image would then be broadcast to and stored at MSs 107 and 109 via DMC links 112, 116 in DMC network 202 of FIG. 2A, would be further broadcast to and stored a MS 155 via DMC link 230 in DMC network 224 of FIG. 2B, and would finally be transmitted to target MS 159 via DMC link 252 in DMC network 204 of FIG. 2C. After the process is finished, i.e., after many separate wireless transmissions of the particular communication were made and all MSs 105, 107, 109, 155, and 159 include a copy of the particular communication, it can be seen in hindsight that the minimum necessary transmissions (and storage) of the particular communication included between MSs 105 and 109 in DMC network 202 of FIG. 2A and between MSs 109 and 159 in DMC network 204 of FIG. 2C, beyond which transmission bandwidth and storage space was essentially wasted in the DTN network. Although an image is described in this example, other communications including audio, video, control, or general data could be transited as well. Furthermore, although the target device in this example is a target MS, in other example, the target device may be an infrastructure device accessible via a particular intermediary MS's predicted future connection with an infrastructure.

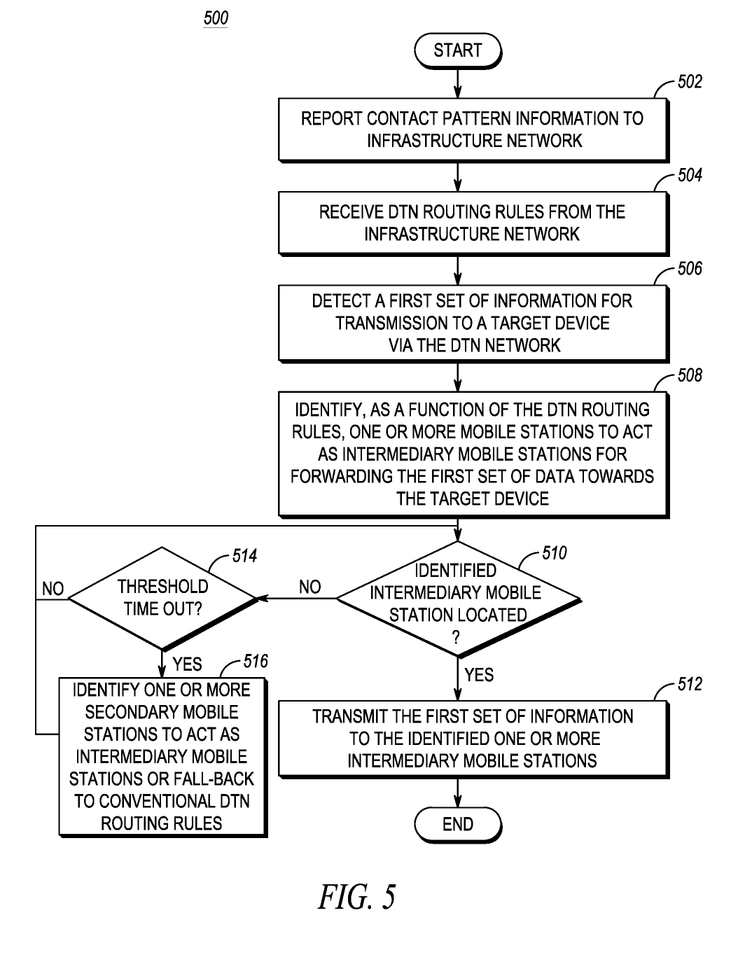

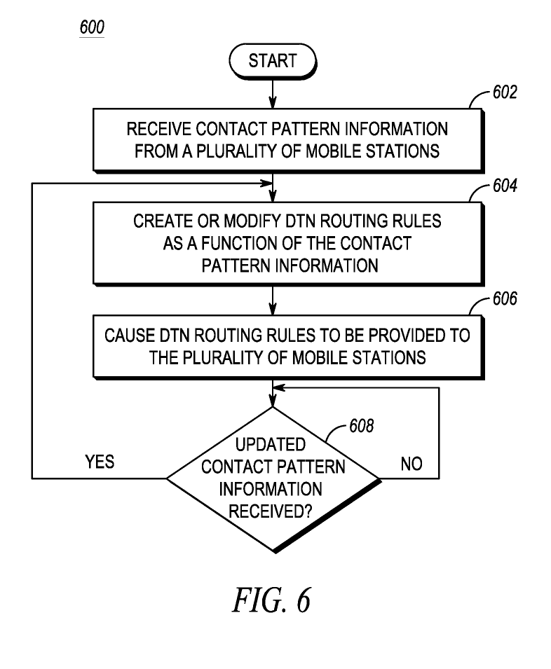

FIGS. 5 and 6 below disclose processes implementable at MSs and infrastructure controller devices that utilize back-end assistance to predict MS movement and contract patterns, and to improve routing through such DTN networks to reduce the bandwidth and storage waste inherent in the conventional store-and-forward DTN routing protocols. Before the description of such processes, device structures of such MSs and infrastructure controller devices will first be described.

### II. MOBILE STATION AND INFRASTRUCTURE CONTROLLER DEVICES

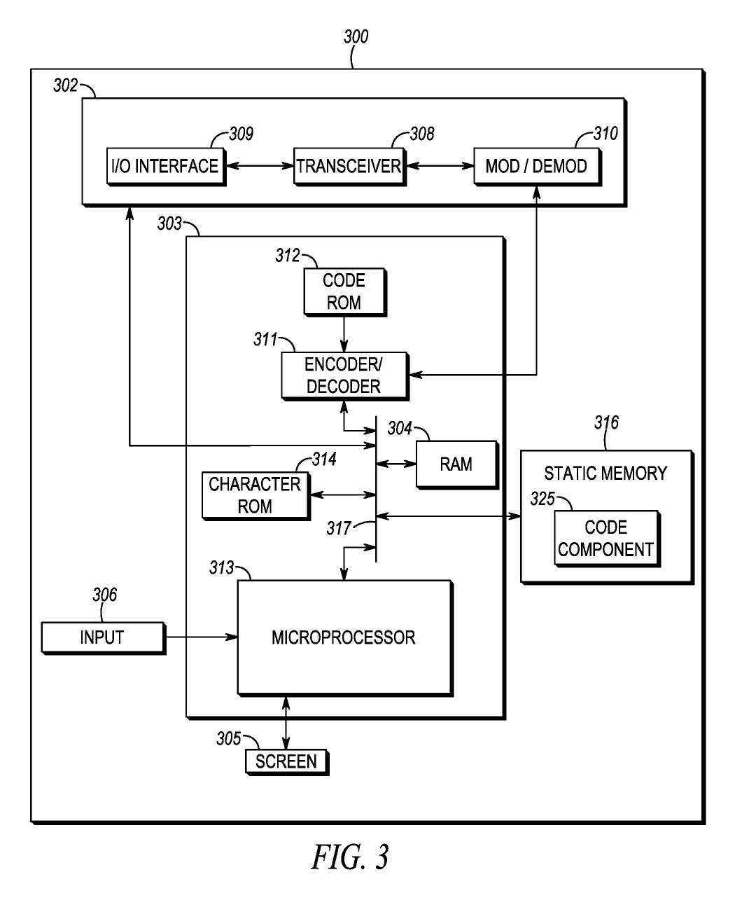

FIG. 3 is an example functional block diagram of a radio controller 300, which may be the same or similar to the controller device 121 of FIG. 1, in accordance with some embodiments. As shown in FIG. 3, radio controller 300 includes a communications unit 302 coupled to a common data and address bus 317 of a processing unit 303. The radio controller 300 may also include an input unit (e.g., keypad, pointing device, etc.) 306 and a display screen 305, each coupled to be in communication with the processing unit 303.

The processing unit 303 may include an encoder/decoder 311 with an associated code Read Only Memory (ROM) 312 for storing data for encoding and decoding voice, data, control, or other signals that may be transmitted or received between the radio controller and BSs or MSs in the system. The processing unit 303 may further include a microprocessor 313 coupled, by the common data and address bus 317, to the encoder/decoder 311, a character ROM 314, a Random Access Memory (RAM) 304, and a static memory 316.

The communications unit 302 may include one or more wired or wireless input/output (I/O) interfaces 309 that are configurable to communicate with MSs, with BSs, and/or with other components in the system infrastructure 103. The communications unit 302 may include one or more wireless transceivers 308, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g, 802.11ac and 802.11p), a WiMAX transceiver perhaps operating in accordance with an IEEE 802.16 standard, Long Term Evolution (LTE) standard, and/or other similar type of wireless transceiver configurable to communicate via a wireless radio network. The communications unit 302 may additionally or alternatively include one or more wireline transceivers 308, such as an Ethernet transceiver, a Universal Serial Bus (USB) transceiver, or similar transceiver configurable to communicate via a twisted pair wire, a coaxial cable, a fiber-optic link or a similar physical connection to a wireline network. The transceiver 308 is also coupled to a combined modulator/demodulator 310 that is coupled to the encoder/decoder 311.

The microprocessor 313 has ports for coupling to the input unit 306 and to the display screen 305. The character ROM 314 stores code for decoding or encoding data such as contact pattern information, DTN routing rules, signaling messages, and/or data or voice messages. Static memory 316 may store operating code for the microprocessor 313 that, when executed, performs one or more of the steps set forth in FIG. 6 and the accompanying text.

Static memory 316 may also store, permanently or temporarily, decoded contact pattern information for one or more, or all, MSs in the system, and may also store, permanently or temporarily, generated DTN routing rules for determining store, carry, and forward routes to transmit communications from any one MS in the system to any another MS in the system using one or more intermediary MSs. Other types of information could be tracked and/or stored in static memory 316 as well.

Static memory 316 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, to name a few.

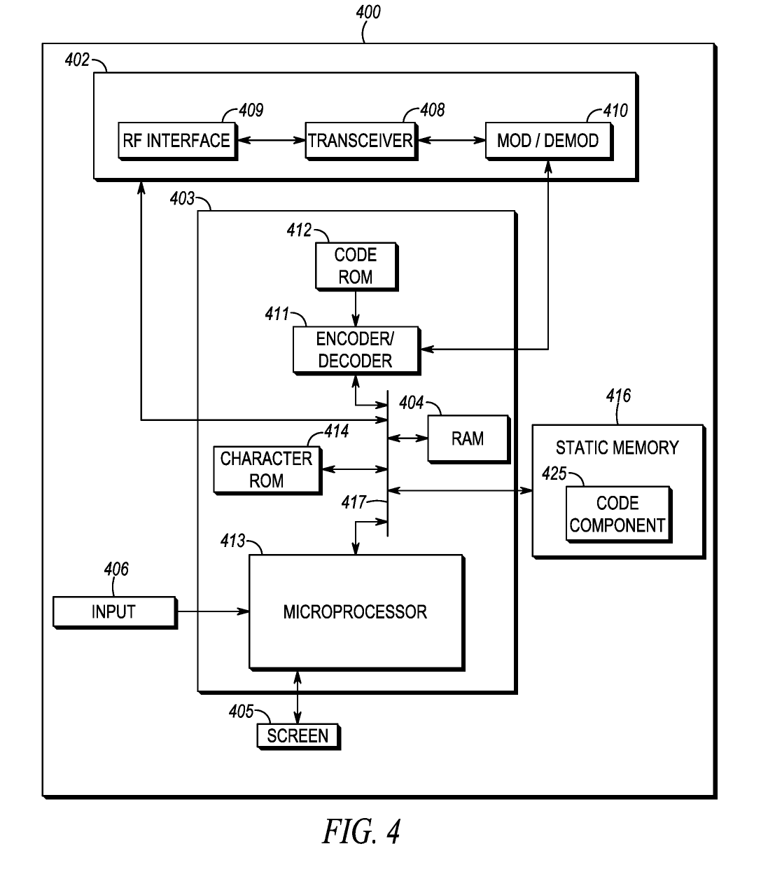

FIG. 4 is an example functional block diagram of a MS 400 such as MS 105 operating within the system 100 of FIG. 1 in accordance with some embodiments. Other MSs such as MSs 107, 109, 155, and 159 may contain same or similar structures. As shown in FIG. 4, MS 400 includes a communications unit 402 coupled to a common data and address bus 417 of a processing unit 403. The MS 400 may also include an input unit (e.g., keypad, pointing device, etc.) 406 and a display screen 405, each coupled to be in communication with the processing unit 403.

The processing unit 403 may include an encoder/decoder 411 with an associated code ROM 412 for storing data for encoding and decoding voice, data, control, and/or other signals that may be transmitted or received by MS 400. The processing unit 403 may further include a microprocessor 413 coupled, by the common data and address bus 417, to the encoder/decoder 411, a character ROM 414, a RAM 404, and a static memory 416.

The communications unit 402 may include an RF interface 409 configurable to communicate with other MSs such as MSs 107, 109, 155, 159, with BSs such as BSs 101, 151, and with controller device 121 via BSs 101, 151 and/or one or more intermediary MSs. The communications unit 402 may include one or more wireless radio transceivers 408, such as a DMR transceiver, a P25 transceiver, a TETRA transceiver, a Bluetooth transceiver, an LTE transceiver, a Wi-Fi transceiver perhaps operating in accordance with an IEEE 802.11 standard, a WiMAX transceiver perhaps operating in accordance with an IEEE 802.16 standard, and/or other similar type of wireless transceiver configurable to communicate via a wireless network. The transceiver(s) are capable of operating in accordance with an infrastructure mode to communicate directly with BSs and in a direct mode to communicate directly with other MSs. The transceiver(s) are also coupled to a combined modulator/demodulator 410 that is coupled to the encoder/decoder 411.

The microprocessor 413 has ports for coupling to the input unit 406 and to the display screen 405. The character ROM 414 stores code for decoding or encoding data such as contact pattern information, DTN routing rules, signaling messages, and/or data or voice messages. Static memory 416 may store operating code for the microprocessor 413 that, when executed, performs one or more of the steps set forth in FIG. 5 and the accompanying text.

Static memory 416 may comprise, for example, a HDD, an optical disk drive such as a CD drive or DVD drive, a SSD, a tape drive, a flash memory drive, or a tape drive, to name a few.

### III. THE PROCESSES FOR BACK-END ASSISTED COMMUNICATION ROUTING IN DTN NETWORKS

FIGS. 5-6 set forth examples of processes for improving DTN routing of transmissions via a back-end assist, from the point of view of a DMC MS (FIG. 5) and then from the point of view of a radio controller in the infrastructure (FIG. 6).

FIG. 5 sets forth an example process 500 in which an originating MS desiring to communicate with a target MS receives back-end assistance from an infrastructure in determining a most favorable route or routes through a DTN network of MSs to reach the target MS, including identifying at least one intermediary first hop MS to which to transmit to reach the target MS.

At step 502, the MS reports contact pattern information to the radio controller in the infrastructure network, via an infrastructure wireless link such as wireless link 111 in FIG. 1 while the MS is within wireless communication range of an infrastructure network, or via the DTN network to the controller device in the infrastructure using intermediary MSs identified by existing DTN routing rules. The contact pattern information may include current information and/or information collected over a period of time in the past, such as over minutes, hours, days, or weeks. The contact pattern information could include, but is not limited to, primary information such as: a timestamp indicating when the MS first detects another MS or infrastructure links (e.g., for each of a plurality of other MSs or infrastructure links detected to be within its communication range), an identity of the another MS or infrastructure (e.g., such as IP address, MAC address, radio ID, etc. of the MS, BS), and a second timestamp indicting when the MS loses contact with the another MS or infrastructure. Additionally, the contact pattern information could include, but is not limited to, secondary information such as: geographic coordinates of the MS and/or of the another MS at the time of each timestamp, a power and/or battery status of the MS and/or the another MS, an average or instantaneous bandwidth utilization and/or traffic level at the MS and/or the another MS, an available storage space at the MS and/or the another MS, a mobility indication of the MS and/or the another MS (e.g., whether it is a portable worn by an individual person or whether it is a vehicular device associated with a vehicle such as a car, bus, or train), a number of past geographic coordinates of the MS and/or of the another MS prior to and/or after a timestamp sufficient to determine a velocity vector of the MS and/or of the another MS, other sensor information of the MS and/or the another MS such as acceleration, the type of wireless interface used to achieve detection or direct connection (e.g., Wi-Fi, Bluetooth, Near-Field, P25, DMR, etc.), the types of wireless interfaces available at the MS and the another MS, and some or all same or similar contact pattern information stored at the another MS. Other types of information could be provided as well.

The aforementioned contact pattern information could be reported to the infrastructure in a number of ways, including being determined by and provided by the MS, obtained by the MS via an information exchange with the another MS and provided by the MS, pre-programmed or pre-associated with the another MS at the MS and provided by the MS, pre-programmed or pre-associated with the MS or another MS in the infrastructure at the radio controller or otherwise made accessible to the radio controller, and/or separately provided to the infrastructure by the another MS and stored at the radio controller or made accessible to the radio controller, among other possibilities.

At step 504, the MS receives, from the radio controller in the infrastructure network via an infrastructure wireless link such as wireless link 111 with BS 101 in FIG. 1 while the MS is within wireless communication range of the infrastructure network, or from the infrastructure via the DTN network, DTN routing rules developed as a function of the contact pattern information provided by the plurality of MSs in the DTN network that identify, for each of a plurality of potential target MSs and/or target infrastructure devices in the DTN network, one or more store, carry, and forward routes through the DTN network via one or more identified intermediary MSs to reach the target MS or infrastructure device without requiring the communications desired to be transmitted to the target device to be broadcast to every MS in the DTN network and without requiring every MS in the DTN network to store the communications. For example, the DTN routing rules may identify a limited number of paths through the DTN network, less than all available paths, that are based on predictions of proximity and/or scheduled proximity using the provided contact pattern information from some, most, or all of the MSs in the DTN network that represent an efficient use of the DMC wireless medium resources and efficient use of the storage capabilities of intermediary MSs in the DTN network. The paths identified in the DTN routing rules and provided to the DMC MSs may be store-and-forward paths (e.g., each intermediary MS stores the communications for as long as necessary until the next-hop intermediary MS or target MS is located and transmission made, after which time the communication(s) may be deleted), may be pass-through paths (e.g., each intermediary MS immediately transmits the communication(s) to a next-hop intermediary MS or target MS and thus does not store the communication(s) for any amount of time beyond that necessary to temporarily buffer the communication(s) for re-transmission), or some combination thereof.

As a result, when an originating MS detects a request to transmit a first communication or a request therefore to a target MS at step 506, and in the absence of an available infrastructure network link, the originating MS can identify at step 508, and as a function of the DTN routing rules, one or more, but less than all, MSs within its current wireless communication range or MSs expected to be within its wireless communication range as first-hop intermediary MSs in a chain of MSs for storing and forwarding the first communication or request therefore towards the target MS via the DTN network.

TABLE I

| Target MS ID | 1^{st} Hop MS | Expected TOA |
|---|---|---|
| 0xABCD | 0xEEEE | 8:02-8:32 |
| 0x0123 | 0x4567, 0x89AB | NULL |
| 0x0A0A | NULL | NULL |

Table I illustrates an example DTN routing rules table that may be received at the MS from the infrastructure. The first row of the rules in Table I shows that if the MS wishes to reach the target MS with an ID of 0xABCD, it should look to a MS with an ID of 0xEEEE that has a predicted time of arrival (TOA) within a DMC wireless communication range of the MS between 8:02 and 8:32 (assuming military time). In this case, the MS with the ID of 0xEEEE may be the only intermediary MS in a chain to the target MS with the ID of 0xABCD, or may be just the first of several intermediary MSs in a chain to the target MS with the ID of 0xABCD. Stated more generally, in some embodiments the DTN routing rules may specify an entire chain of all intermediary MSs on a path to each reachable target MS, an identical copy of which may be provided by the infrastructure to every MS and which and may be included in each transmission of the communication to each subsequent intermediary MS on the way to the target MS in order to ensure that each intermediary MS has obtained a copy. In other embodiments, unique DTN routing rules may be separately provided to and stored at the intermediary MSs that may only identify a next-hop MS (first-hop MS relative to each intermediary MS in the path to the target MS) and expected TOA of that next-hop MS in the path to the target MS. In the latter case, a copy of the DTN routing rules would not be sent via DMC as each unique set of rules would not be helpful to any other MS on the path to the target MS.

The second row of the rules in Table I shows that if the MS wishes to reach the target MS with an ID of 0x0123, it should look to one or both MSs having IDs of 0x4567 and 0x89AB. In this example, the DTN routing rules identify more than one route (but still less than all possible routes) to improve reliability of the transmission from the originating source MS to the target MS. The expected TOA is set to NULL to indicate that MSs having IDs of 0x4567 and 0x89AB were always detected to be within DMC wireless communication range of the MS. In this case, the originating MS may determine, if both intermediary MSs are indeed found within a wireless communication range of the MS, to randomly select one of the two or to transmit the same first communication to both. The identification of two MSs increases redundancy in the event that the predictions made in the infrastructure are incorrect or delayed, but still saves bandwidth and storage space over broadcasting the first communication to every single MS within communication range of the originating and/or intermediary MSs.

The third row of the rules in Table I shows that, in some instances, there may currently be no route available between a particular originator MS and a target MS (here, indicated via NULL), or that in some instances a time to reach the target MS (calculated by the infrastructure) exceeds a threshold maximum time set in the infrastructure. In this case, the originator MS would need to indicate, via its user interface, an error in contacting the indicated target MS. In some embodiments, the MS may indicate that no current route exists, but may provide an option via its user interface to store the communication for future transmission when an infrastructure connection becomes available or when updated DTN routing rules are received. If a new DMC or infrastructure-route becomes available, the stored communication could then be transmitted via the newly available route.

At step 510, the MS determines whether the intermediary MS(s) identified at step 508 are located during the expected TOA, and if so, proceeds to step 512 where the MS transmits the first communication directly to the identified one or more first-hop intermediary MSs. In some embodiments, the MS may wait for an acknowledgment that the target MS received the communication, and after a threshold period of time without receiving the acknowledgment, may return to step 508 and identify one or more backup or alternative first hop intermediary MSs, if available, that may be specified in the DTN routing rules.

Returning to step 510 if, on the other hand, the intermediary MS(s) identified at step 508 are not located within the expected TOA, processing proceeds to step 514, where the MS may wait for some threshold period of time after expiration of the TOA, to allow for some flexibility in timing and refrain from too hastily identifying a secondary but perhaps less optimal route. If the threshold period of time has not expired, processing may proceed back to step 510 to determine if the identified MSs can now be located. If, however, it is determined at step 514 that the threshold period of time has expired, processing proceeds to step 516. In one embodiment, at step 516 the MS identifies one or more secondary MSs to act as intermediary MSs, different from the MSs identified at step 508, and processing proceeds back to step 510 using the secondary MSs. In another embodiment, the first or a subsequent time step 516 is executed, the MS may fall back to a conventional pre-programmed DTN routing mechanism that, for example, may identify all available MSs within DCM range as intermediary mobile stations. Other fall-back pre-programmed DTN routing mechanisms could be used as well.

While steps 502, 504 and steps 506-516 are illustrated in a serial manner for ease of illustration, in some embodiments, steps 502 and 504 may be occurring continuously, even in parallel with steps 506-516, and corresponding continually updated contact pattern information periodically provided back to the infrastructure (when available) and updated DTN routing rules provided to the MS (when available), so that the DTN routing rules are continually being updated at MSs in the DTN network.

As one example of the process 500, and with respect to FIGS. 1 and 2A-2C, MSs 105-109, 155, 159 may track the MSs they come into contact with and the time of day during which they are in contact with them, and perhaps other secondary information as set forth above and, at some point when they come into contact with an infrastructure network (or via the DTN network using existing DTN routing rules), perhaps via BSs 101, 151, report all of this information as contact pattern information to the controller device 121 of FIG. 1 (step 502). After reporting such information, each of the MSs 105-109, 155, 159 receives DTN routing rules from the controller device 121 (step 504).

MS 105, for example, may then detect a request to transmit an image to target MS 159 (step 506). MS 105 may identify, while now outside of the infrastructure network of FIG. 1 but while in the DTN network 202 of FIG. 2A, and with reference to DTN routing rules previously received from the infrastructure, a route (or at least identify the first hop intermediary MS 109) to the target MS 159 via MS 109 (step 508). MS 105 may then determine that it is within wireless communication range of the identified MS 109 (step 510) and transmit the image to MS 109 in FIG. 2A (step 512) via DCM link 112, without wasting wireless resources transmitting the image to, and without storing the image at, MS 107. MS 109 is either provided with an identity of the next-hop intermediary MS by MS 105 (in this case, the target MS 159) or references its own DTN routing rules to determine how to get the communication or request to the target MS 159. In this case MS 109 determines that it expects to come within DCM range of MS 159 in the future (perhaps identifying a specific TOA in the future as well), and therefore stores the image (and does not transmit it to MS 155 while in network 224) until it arrives at network 204, without wasting wireless resources transmitting the communication to, or storage storing the communication at, MS 155 while in network 224 in FIG. 2B. Subsequently, MS 109 arrives in network 204 and determines that it is within DCM wireless range of target MS 159, at which time it transmits the image to MS 159 via DCM link 252.

FIG. 6 sets forth an example process flow 600 in which a radio controller device in the infrastructure provides assistance to DTN MSs in determining a most favorable route or routes through an DTN network of MSs including one or more intermediary MSs to reach a target MS.

At step 602, the radio controller receives contact pattern information from a plurality of MSs. The contact pattern information received at step 602 may be the same or similar to the contact pattern information described with respect to step 502 of FIG. 5.

At step 604, the radio controller creates a new set (or modifies an existing set) of DTN routing rules for the MSs reporting contact pattern information in the radio system in which it operates. The DTN routing rules are formed as a function of the reported contact pattern information, and indicate, for each of an originating and target MS and/or target infrastructure device pair, one or more store, carry, and forward routes through the DTN network via one or more identified intermediary MSs to reach the target MS or infrastructure device without requiring the communication desired to be transmitted to the target device to be broadcast to every MS in the DTN network and without requiring every MS in the DTN network to store the communication. The DTN routing rules also may indicate an expected TOA for the one or more next-hop intermediary MSs to arrive within a DCM wireless range of the transmitting MS. As set forth earlier, in some embodiments, the DTN routing rules may specify an entire chain of intermediary (next-hop) MSs and corresponding TOAs between the originating MS and target MS.

The radio controller in the infrastructure may use wireless system modeling tools such as NS-2, OMNET++, J-Sim, GloMoSim, or others to simulate DCM wireless coverage given the contact pattern and location information provided in the contact pattern information from the MSs, and known or determined characteristics of wireless interfaces available at the MSs. The radio controller may use the movement information provided by the MSs to predict future movement of the MSs along same/similar paths and based on similar characteristics (e.g., time of day, location, response status, detected velocity, etc.), and/or may use scheduling information based on some association of the MS (self-reported or pre-configured at the radio controller) with a regular movement, such as based on a known train or bus schedule with which a particular MS is reported to or pre-configured to be associated with.

Where more than one route is determined to exist between source and target MSs via the modeling, the radio controller may prioritize those intermediary MSs having preferred characteristics, as determined via the contact pattern secondary information, such as lower transmission loads, higher storage availability, higher battery capacity, faster wireless interface availability, larger battery or higher remaining charge, earlier expected arrival time at the target MS, lower velocity, or other information made available to the radio controller. In some embodiments, the radio controller may access locally stored information that is pre-populated or separately reported by MSs with MS characteristic and/or capability information as well in determining DTN routing rules. The resultant unique and/or common DTN routing rules may be the same or similar to those set forth above with respect to step 504 of FIG. 5.

At step 606, the radio controller causes the unique or common DTN routing rules created or modified at step 604 to be provided to each MS in the DTN network via the infrastructure connection (e.g., for those MSs having a current connection to the infrastructure) and/or via the DTN network. In some instances, a MS that was within infrastructure coverage and reported contact pattern information may move out of infrastructure coverage by the time the DTN routing rules are created or updated. In other instances, the radio controller may update the DTN routing rules in a manner that affects one or more missing MSs that do not currently have an infrastructure link to the infrastructure and thus to the radio controller. In such cases, the radio controller may wait until the next time the missing MS(s) connects to the infrastructure and then transmit a notice to the MS that new or updated DTN routing rules are available (or may simply transmit them without prior notice). In some embodiments, the radio controller may explicitly request or implicitly rely on MSs that do have current connections to the infrastructure to provide the new or updated copy of the DTN routing rules to the missing MS(s) when they come into DMC wireless range of them. In the latter case, the radio controller may provide a list of MS identifiers that it has not yet been able to provide a new or updated copy of the (unique or common) DTN routing rules to, so that DMC MSs operating in the DTN network can determine whether a MS that it detects or connects to needs the new or updated DTN routing rules. In such a case, the MS could provide the new or updated DTN routing rules to the missing MS via a DMC link in the DTN network.

At step 608, the radio controller determines if updated contact pattern information has been received from one or more DMC MSs in the DTN network. If so, processing proceeds back to step 604 where DTN routing rules are modified to incorporate the updated information. If, on the other hand, no updated contact pattern information has been received, processing loops back to step 608.

As one example of the process 600, and with respect to FIGS. 1 and 2A-2C, MSs 105-109, 155, 159 may track their location as they move from FIG. 2A to 2B and then finally to 2C, track the MSs they come into contact with and the time of day during which they are in contact with them, and other secondary information as set forth above and, at some point when they come into contact with an infrastructure network, perhaps via BSs 101, 151, report all of this information as contact pattern information to the controller device 121 of FIG. 1 (step 602). After reporting such information, the radio controller creates or modifies DTN routing rules (step 604) that set forth at least a next intermediary MS or an entire route for any source MS of MSs 105-109, 155, 159 to any target MS of MSs 105-109, 155, 159, assuming a route exists, in the manner as set forth above. Subsequently, the radio controller causes the DTN routing rules to be provided to each of the MSs 105-109, 155, 159 (step 606), when they come within range of an infrastructure, for use in communicating across the DTN networks 202, 204, 224 in a more efficient manner.

For example, FIGS. 2A-2C may represent a movement of MSs 105-109, 155, 159 over a day, and the DTN routing rules may rely on future predicted movement similar to the detected past movement. Furthermore, additional information reported by the MSs as set forth above may determine whether the radio controller sets one possible route over another. For example, if MS 105 in network 202 of FIG. 2A wishes to transmit to MS 155, the radio controller may, depending on characteristics of MS 109, have MS 109 provide the information to MS 109 in network 202 of FIG. 2A and then to MS 155 in network 224 of FIG. 2B, or may instruct MS 105 in network 202 of FIG. 2A to wait for MS 155 to make it to network 202 in FIG. 2C. Other considerations are possible as well.

### III. CONCLUSION

In accordance with the foregoing, an improved device, system, and method for routing communications or requests therefore in a DTN network in a more intelligent and efficient manner using back-end infrastructure assistance is disclosed. As a result, MS storage resource utilization and DMC wireless medium resource utilization can be reduced.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method of transmitting communications in a disruption tolerant network (DTN) including a plurality of mobile stations, the method comprising:
reporting, by a first mobile station, to an infrastructure network, contact pattern information comprising identities of other mobile stations and infrastructure devices determined to be within direct communication range and indications of times at which the other mobile stations and infrastructure devices were determined to be within direct communication range of the first mobile station;
receiving, by the first mobile station, from the infrastructure network a set of DTN routing rules for routing communications to any one of the plurality of mobile stations and infrastructure devices via the DTN network;
detecting, by the first mobile station, a first communication for transmission to a target device out of the plurality of mobile stations and infrastructure devices via the DTN network;
identifying, by the first mobile station, as a function of the set of the DTN routing rules, one or more but less than all mobile stations (i) currently within wireless communication range of the first mobile station or (ii) not currently within but expected to be within wireless communication range of the first mobile station, to act as intermediary mobile stations for storing and forwarding the first communication towards the target device; and
transmitting, by the first mobile station, the first communication to the identified one or more intermediary mobile stations when they are determined to be within direct wireless communication range.

2. The method of claim 1, wherein the step of identifying comprises identifying, by the first mobile station, as a function of the set of the DTN routing rules, one or more but less than all mobile stations currently within wireless communication range of the first mobile station to act as intermediary mobile stations for storing and forwarding the first communication towards the target device

3. The method of claim 1, wherein the step of identifying comprises identifying, by the first mobile station, as a function of the set of the DTN routing rules, one or more but less than all mobile stations not currently within but expected to be within wireless communication range of the first mobile station to act as intermediary mobile stations for storing and forwarding the first communication towards the target device when the one or more mobile stations are determined to be within wireless communication range.

4. The method of claim 1, wherein the contact pattern information further comprises information regarding storage space available at the first mobile station.

5. The method of claim 1, wherein the contact pattern information further comprises indications of bandwidth utilization or traffic levels at the first mobile station.

6. The method of claim 1, wherein the contact pattern information further comprises power or battery status information associated with the first mobile station.

7. The method of claim 1, wherein the contact pattern information includes information identifying which of a plurality of different direct mode wireless interface types available at the first mobile station was used in determining respective identities of other mobile stations determined to be within communication range.

8. The method of claim 1, wherein the transmitting, by the first mobile station, the first communication to the identified one or more mobile stations when they are within wireless communication range occurs while the first mobile station lacks a wireless connection to the infrastructure network.

9. The method of claim 1, wherein the set of DTN routing rules include routes based on scheduled contacts with other mobile stations in the DTN network and based on predicted contacts with other mobile stations in the DTN network.

10. The method of claim 1, wherein the set of DTN routing rules set forth a route in the DTN network for transmitting a communication from any known source mobile station to any known destination mobile station, if available within a threshold period of time, as a function of contact pattern information collected from all known mobile stations in the DTN network.

11. The method of claim 1, wherein the step of identifying includes identifying, by the first mobile station, as a function of the set of the DTN routing rules, a single mobile station (i) currently within wireless communication range of the first mobile station or (ii) not currently within but expected to be within wireless communication range of the first mobile station to act as an intermediary mobile station for storing and forwarding the first communication towards the target device.

12. The method of claim 1, wherein each of the identified one or more mobile stations at least temporarily store the first communication and further route the first communication towards the target device using respective second sets of DTN routing rules received from the infrastructure for routing communications to any one of the plurality of mobile stations via the DTN network.

13. The method of claim 12, wherein the second sets of DTN routing rules are identical to the first set of DTN routing rules.

14. A mobile station comprising:
a direct mode wireless interface for communicating via a disruption tolerant network (DTN);
an infrastructure mode wireless interface for communicating with an infrastructure network;
a memory; and
a processor configured to perform a set of functions, the set of functions comprising:
reporting, via one of the infrastructure mode wireless interface and the direct mode wireless interface, to the infrastructure network, contact pattern information comprising identities of other mobile stations and infrastructure devices determined to be within direct communication range and indications of times at which the other mobile stations and infrastructure devices were determined to be within direct communication range of the first mobile station;
receiving, via one of the infrastructure mode wireless interface and the direct mode wireless interface, and from the infrastructure network, a set of DTN routing rules for routing communications to any one of the plurality of mobile stations and infrastructure devices via the DTN network;
detecting a first communication for transmission to a target device out of the plurality of mobile stations and infrastructure devices via the DTN network;
identifying, as a function of the set of the DTN routing rules, one or more but less than all mobile stations (i) currently within wireless communication range of the first mobile station or (ii) not currently within but expected to be within wireless communication range of the first mobile station to act as intermediary mobile stations for storing and forwarding the first communication towards the target device; and
transmitting, via the direct mode wireless interface, the first communication to the identified one or more mobile stations when they are determined to be within direct wireless communication range.

15. The mobile station of claim 14, wherein the function of identifying comprises identifying, as a function of the set of the DTN routing rules, one or more but less than all mobile stations currently within wireless communication range of the first mobile station to act as intermediary mobile stations for storing and forwarding the first communication towards the target device.

16. The mobile station of claim 14, wherein the function of identifying comprises identifying, as a function of the set of the DTN routing rules, one or more but less than all mobile stations not currently within but expected to be within wireless communication range of the first mobile station to act as intermediary mobile stations for storing and forwarding the first communication towards the target device when the one or more mobile stations are determined to be within wireless communication range.

17. The mobile station of claim 14, wherein the function of transmitting, via the direct mode wireless interface, the first communication to the identified one or more mobile stations when they are within wireless communication range occurs while the infrastructure mode wireless interface lacks an active connection to the infrastructure network.

18. A method of routing communications in a disruption tolerant network (DTN) via infrastructure-network generated DTN routing rules, the method comprising:
receiving, at a radio controller in an infrastructure network, contact pattern information from a plurality of mobile stations, the contact pattern information comprising, for each particular mobile station out of the plurality of mobile stations, identities of other mobile stations and infrastructure devices determined to be within communication range of the particular mobile station and indications of times at which the other mobile stations and infrastructure devices were determined to be within communication range of the particular mobile station;
creating, at the radio controller, DTN routing rules as a function of the contact pattern information that,
for each of an originating mobile station and target device pair, identifies one or more store, carry, and forward routes but less than all store, carry, and forward routes through the DTN network via one or more identified intermediary mobile stations to reach the target device; and
causing, by the radio controller, some or all of the DTN routing rules to be provided, from the infrastructure network, to each of the plurality of mobile stations.

19. The method of claim 18, further comprising:
receiving, by the radio controller, updated contact pattern information from at least one of the plurality of mobile stations;
modifying, by the radio controller, the DTN routing rules as a function of the updated contact pattern information to created updated DTN routing rules; and
causing, by the radio controller, some or all of the updated DTN routing rules to be provided to each of the plurality of mobile stations when they come within wireless communication range of a base station of the infrastructure network.

20. The method of claim 18, wherein the contact pattern information further comprises one or more of (i) information regarding storage space availability at the particular mobile station, (ii) indications of an amount of bandwidth used or a traffic level at the particular mobile station, (iii) power or battery status information associated with the particular mobile station, and (iv) information identifying which of a plurality of different direct mode wireless interface types available at the particular mobile station was used in determining respective identities of other mobile stations determined to be within communication range.
